(19) United States
(12) Patent Application Publication
(10) Pub. No.: US 2009/0100948 A1
(43) Pub. Date: Apr. 23, 2009

(54) RECTILINEAR-MOTION ACTUATOR

(76) Inventors: Takashi USHIKU, Matsudo-shi (JP); Eiji MAYUMI, Matsudo-shi (JP)

Correspondence Address: MCGLEW AND TUTTLE, P.C., SCARBOROUGH STATION, SCARBOROUGH, NY, 10510-9227, US

(21) Appl. No.: 12/241,118

(22) Filed: Sep. 30, 2008

(30) Foreign Application Priority Data
Oct. 19, 2007 (JP) 2007-271974
Jan. 28, 2008 (JP) 2008-016208

(51) Int. Cl. F16H 21/18

(52) U.S. Cl. 74/49

(57) ABSTRACT

A rectilinear-motion actuator includes a motor, a reduction gear mechanism coupled with a motor shaft of the motor, and a rectilinear, reciprocative motion mechanism for converting a rotary motion of a last-stage gear of the reduction gear mechanism to a rectilinear, reciprocative motion. The last-stage gear has a pin provided thereon which is offset from its center of rotation. The rectilinear, reciprocative motion mechanism includes a movable plate having a slit and allowing the pin to move within the slit. The slit is arranged orthogonally to the axis of the motor shaft. The longitudinal center of the slit is located on a line in parallel with the motor shaft axis and passing through the center of the last-stage gear. The axis of reciprocative motion of the movable plate is offset from the line passing through the center of the last-stage gear in a direction away from the motor shaft.

### BACKGROUND OF THE INVENTION

1. Field of the Invention

The present invention relates to a rectilinear-motion actuator which converts a rotary motion of a motor to a rectilinear, reciprocative motion and outputs the reciprocative motion and which can be used with, for example, a simplified seat-unlocking device of an automobile.

2. Description of the Related Art

FIG. 11 shows the configuration of a conventional rectilinear-motion actuator disclosed in Japanese Patent Application Laid-Open (kokai) No. 4-295249. In the rectilinear-motion actuator of FIG. 11, a motor is mounted on a mounting plate within a frame; a worm is provided on a motor shaft of the motor; and the speed of the motor is reduced by means of a worm wheel meshed with the worm. The worm wheel is provided with a rectilinear, reciprocative locomotion mechanism which can provide a rectilinear, reciprocative motion. Specifically, an elongated groove is formed in a guide section provided on the worm wheel. As the worm wheel rotates, a pin provided on a fixture plate attached to the worm wheel slidably moves within the elongated groove. At this time, a rod coupled with the guide section is supported by a rod guide provided on the frame and performs a rectilinear, reciprocative motion.

The rectilinear-motion actuator of FIG. 11 achieves reduction in size of an actuator unit through improvement of reduction gear ratio implemented by employment of a worm-type reduction gear mechanism. However, since the worm meshed with the worm wheel is disposed orthogonally to the axis of a rectilinear, reciprocative motion (i.e., the motor shaft is orthogonal to the rod), an idle space arises. Even when the rod is disposed in parallel with the motor shaft, the width of the actuator unit (a dimension of the actuator unit as measured in a direction orthogonal to the direction of the rectilinear, reciprocative motion) is the sum of the outside diameter of the worm wheel and the radius of the motor. This is disadvantageous in view of reduction in size.

### SUMMARY OF THE INVENTION

An object of the present invention is to solve the above-mentioned problems and to provide a rectilinear-motion actuator which exhibits a reduced size implemented through reduction in width of an actuator unit and in which the centerline of a movable plate (corresponding to the above-mentioned rod) is offset from the center of a last-stage gear so as to utilize a force at a weakest-pulling-force position for conversion to a rectilinear, reciprocative motion with involvement of little loss.

To achieve the above object, a rectilinear-motion actuator of the present invention comprises a motor; a reduction gear mechanism coupled with a motor shaft of the motor; and a rectilinear, reciprocative motion mechanism for converting a rotary motion of a last-stage gear of the reduction gear mechanism to a rectilinear, reciprocative motion. The last-stage gear has a pin provided thereon which is offset from its center of rotation. The rectilinear, reciprocative motion mechanism comprises a movable plate having a slit having a predetermined width and length, and allowing the pin to move within the slit. An axis of reciprocative motion of the movable plate is offset from a line passing through a center of the last-stage gear.

The reduction gear mechanism has a worm fixed to the motor shaft, and a worm wheel meshed with the worm. The movable plate has another slit whose width is halved by the axis of reciprocative motion of the movable plate and which receives a rotary shaft of the worm wheel so as to avoid interference of the rotary shaft with the movable plate. A helical gear is coaxially provided on the rotary shaft of the worm wheel, and the last-stage gear is meshed with the helical gear. An output-member-attaching portion to which a load is attached is provided at an end portion of the movable plate in alignment with the axis of reciprocative motion of the movable plate. The pin provided on the last-stage gear has a sleeve fitted externally thereto.

The rectilinear-motion actuator of the present invention further comprises a position detection mechanism for detecting a position of a movable section. A rotational speed or a rotational torque of the motor is varied according to a detected position of the movable section. The position detection mechanism detects a rotational position of the last-stage gear.

An elastic member is disposed so as to act on the movable plate. The movable plate is in a U-shaped configuration such that a first arm, whose axis coincides with the axis of reciprocative motion, and a second arm, on which the elastic member acts, are disposed on opposite sides of the line passing through the center of the last-stage gear. The elastic member is a coil spring which assists the movable plate with a pulling drive force in the course of pulling movement of the movable plate and which functions as a load in the course of pushing movement of the movable plate.

The rectilinear-motion actuator of the present invention has the following structure: the rotary shaft of the worm wheel is offset from the line passing through the center of the last-stage gear and extends through the slit of the movable plate. Thus, the rectilinear-motion actuator can utilize a force at a weakest-pulling-force position for conversion to a rectilinear, reciprocative motion with involvement of little loss. Also, the diameter of the worm wheel can be reduced as compared with the last-stage gear, whereby the width of the actuator unit can be reduced.

In the case where the rectilinear-motion actuator is used with a simplified seat-unlocking device, at the time of returning a wire for locking a seat subsequent to an operation of unlocking the seat by pulling the wire, the motor is under near no load; thus, the rotational speed of the motor increases, so that noise increases. In order to cope with this problem, at the time of returning the wire, a series resistor can be connected to the motor, whereby an associated voltage drop lowers the rotational speed of the motor. Alternatively, in place of use of the series resistor for decelerating the motor, a spring can be used for decelerating a return movement through utilization of compression of the spring. In the case of use of the spring, at the time of driving a load, a drive force can be enhanced while a motor current is lowered.

### BRIEF DESCRIPTION OF THE DRAWINGS

FIG. 1 is a top view showing the overall configuration of a rectilinear-motion actuator according to a first embodiment of the present invention;

FIG. 2 is a sectional view of the rectilinear-motion actuator of the first embodiment shown in FIG. 1;

FIGS. 3A and 3B are views for explaining actions realized by an offset of the centerline of a movable plate from the center of rotation of a helical gear C (last-stage gear);

FIG. 4 is a view showing an example circuit configuration for driving the rectilinear-motion actuator of the first embodiment shown in FIG. 1;

FIG. 5 is a top view showing the overall configuration of a rectilinear-motion actuator according to a second embodiment of the present invention;

FIG. 6 is a vertical sectional view, taken along the centerline of a movable plate, of the rectilinear-motion actuator of the second embodiment shown in FIG. 5;

FIG. 7 is a view for explaining actions of a movable plate;

FIG. 8 is a diagram showing output characteristics of the rectilinear-motion actuators;

FIG. 9 is a diagram showing load current characteristics of a motor as observed during a single reciprocation of the movable plate;

FIG. 10 is a view showing an example circuit configuration for driving the rectilinear-motion actuator of the second embodiment shown in FIG. 5; and

FIG. 11 is a view showing the configuration of a conventional rectilinear-motion actuator.

### DETAILED DESCRIPTION OF THE PREFERRED EMBODIMENTS

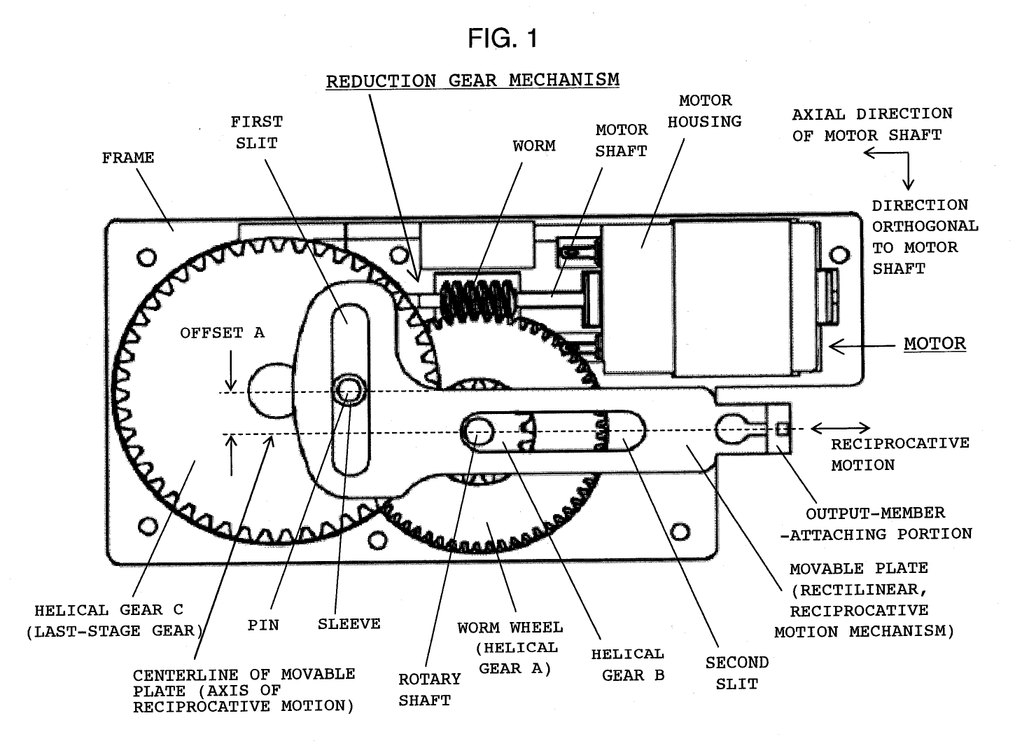

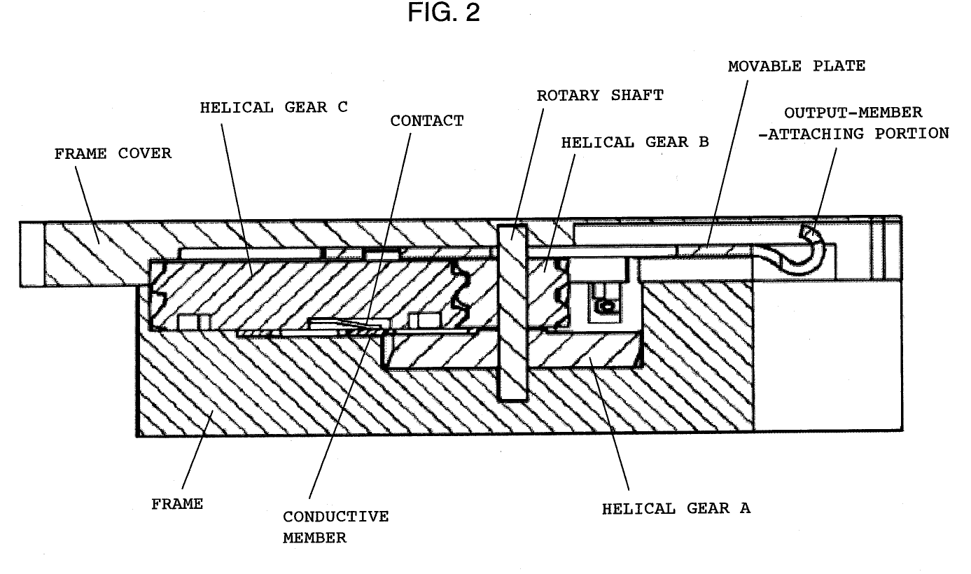

The present invention will now be described by way of examples. FIG. 1 is a top view showing the overall configuration of a rectilinear-motion actuator according to a first embodiment of the present invention. FIG. 1 shows a state in which a frame cover is removed. FIG. 2 is a sectional view of the rectilinear-motion actuator of the first embodiment shown in FIG. 1. The rectilinear-motion actuator includes a motor, a reduction gear mechanism, and a rectilinear, reciprocative motion mechanism, which includes a movable plate. These components and mechanisms are fixedly disposed within a frame (made of, for example, a resin). A frame cover (made of, for example, a resin) is attached to the upper side of the frame. The motor can be, for example, an ordinary DC commutator motor. The illustrated motor is fixed in a recess provided in the frame. A motor shaft serves as a motor output shaft and projects to the exterior of the motor from the center of one side face of a motor housing. The reduction gear mechanism is coupled with the motor shaft.

The reduction gear mechanism includes a worm fixed to the motor shaft by, for example, press-fitting; a worm wheel (helical gear A); a helical gear B; and a helical gear C, which serves as a last-stage gear. The worm wheel (helical gear A) is disposed in such a manner as to be meshed with the worm. A rotary shaft rotatably supported by the frame supports the helical gear A at the center of the gear. Thus, a rotation about the motor shaft generated by the motor is converted to a rotation about the rotary shaft orthogonal to the motor shaft and is reduced in speed by means of the worm gear and the helical gear A (in the illustrated embodiment, speed reduction at a reduction gear ratio of 61:1). Next, in the illustrated embodiment, the rotation transmitted to the helical gear A is reduced in speed by means of the helical gear B fixed on the rotary shaft of the helical gear A, and a helical gear C meshed with the helical gear B (in the illustrated embodiment, speed reduction at a reduction gear ratio of 3.133:1; the overall reduction gear ratio is 191:1).

Next, a rotation of the helical gear C is converted to a rectilinear, reciprocative motion of the movable plate, which partially constitutes the rectilinear, reciprocative mechanism, via a pin, which is fixed on the helical gear C at a position offset from the center of the helical gear C. The direction of the rectilinear, reciprocative motion is in parallel with the axis of the motor shaft. The movable plate assumes a perpendicularly bent shape resembling the letter L. The movable plate has a first slit (elongated hole) and a second slit (elongated hole), which are formed in its respective portions extending orthogonally to each other.

The first slit is arranged such that its longitudinal direction is orthogonal to the axis of the motor shaft and such that its longitudinal center is located on a line in parallel with the axis of the motor shaft and passing through the center of the last-stage gear. The pin provided on the helical gear C can move within the first slit. A sleeve is externally fitted to the pin in a slidably rotatable manner. When the pin moves within the first slit, the sleeve rotates, thereby lowering frictional force. The axis of reciprocative motion of the movable plate is offset from the line passing through the center of the last-stage gear in a direction away from the motor shaft (indicated as “offset A” in FIG. 1). The offset of the centerline (axis of reciprocative movement) of the movable plate enables reduction in width of an actuator unit and, as will be described in detail later, enables utilization of force at a weakest-pulling-force position for conversion to a rectilinear, reciprocative motion with involvement of little loss.

The second slit is arranged such that its width is halved by the axis of reciprocative motion of the movable plate and such that its longitudinal direction is in parallel with the axis of the motor shaft. The second slit is provided for receiving the common rotary shaft of the helical gear A and the helical gear B so as to avoid interference of the rotary shaft with the movable plate. The movable plate is guided as follows: a groove is provided in the frame or the frame cover, and the movable plate is fitted into the groove in such a manner as to be reciprocatively movable while being guided in a restrictive manner from opposite sides. The second slit functions as a guide for positioning the movable plate in a direction orthogonal to the motor shaft and as an additional guide for movement of the movable plate.

As a result, the second slit is also offset from the longitudinal center of the first slit (thus, from the center of the helical gear C) in the direction away from the motor shaft (thus, downward in FIG. 1). An offset A between the slits is equal to the offset between the center of rotation of the helical gears A and B and the center of rotation of the helical gear C.

By virtue of the above-mentioned configuration, by means of the pin moving within the first slit provided in the movable plate, the rotation of the motor is converted to a rectilinear, reciprocative motion of the movable plate. A distal end of the movable plate, which reciprocatively moves, has an output-member-attaching portion in alignment with the axis of reciprocative motion and to which an output member (wire or rod, not shown) is attached. The other end of the output member (not shown) is coupled with an external load, such as a simplified seat-unlocking device. The output member drives the external load in a pulling direction or a pushing direction.

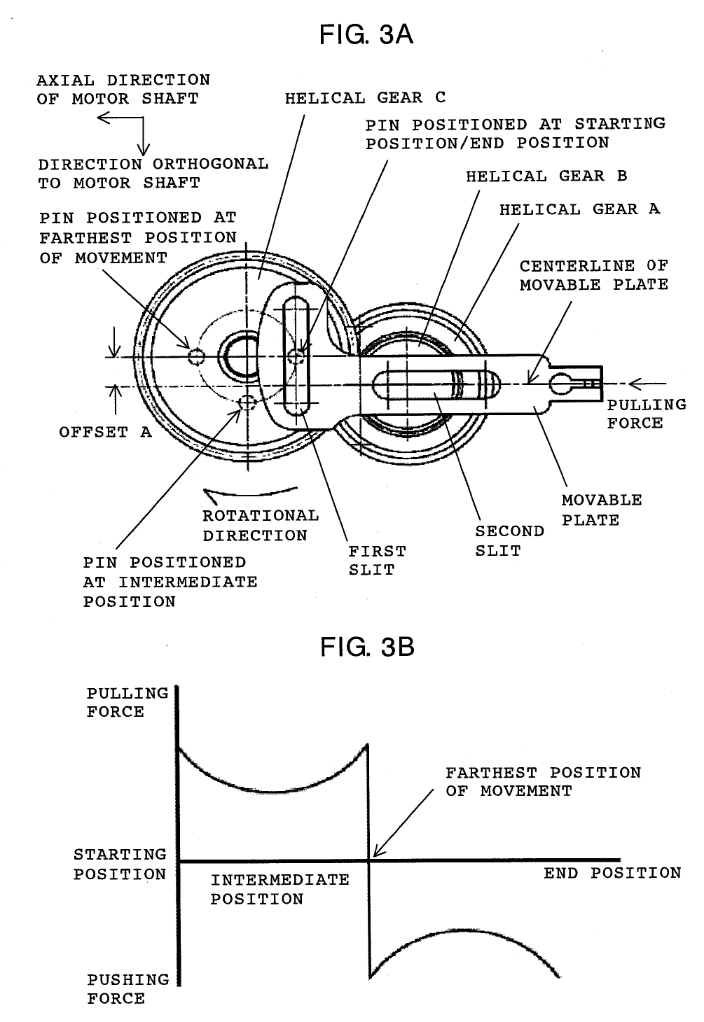

FIG. 3 is a view for explaining actions realized by the offset of the centerline of the movable plate (offset of the second slit positionally coinciding with the centerline) from the center of rotation of the helical gear C (last-stage gear). This offset is indicated as “offset A” in FIG. 3. The illustrated rectilinear-motion actuator has such a structure that the common rotary shaft of the helical gears A and B (thus, the second slit) is located on the offset axis, so that the rotary shaft can extend through the second slit. The offset of the centerline enables utilization of force at the weakest-pulling-force position for conversion to a rectilinear, reciprocative motion with involvement of little loss.

FIG. 3A shows three positions of the pin provided on the helical gear C during rotation of the helical gear C; namely, a starting position/end position, an intermediate position, and a farthest position of movement. As shown in FIG. 3B, during a single clockwise rotation of the helical gear C from the starting position, the pin pulls the movable plate in the course of travel from the starting position to the farthest position of movement and pushes the movable plate in the course of travel from the farthest position of movement to the end position. At this time, pulling force has a characteristic as shown in FIG. 3B and assumes a minimum value at the intermediate position.

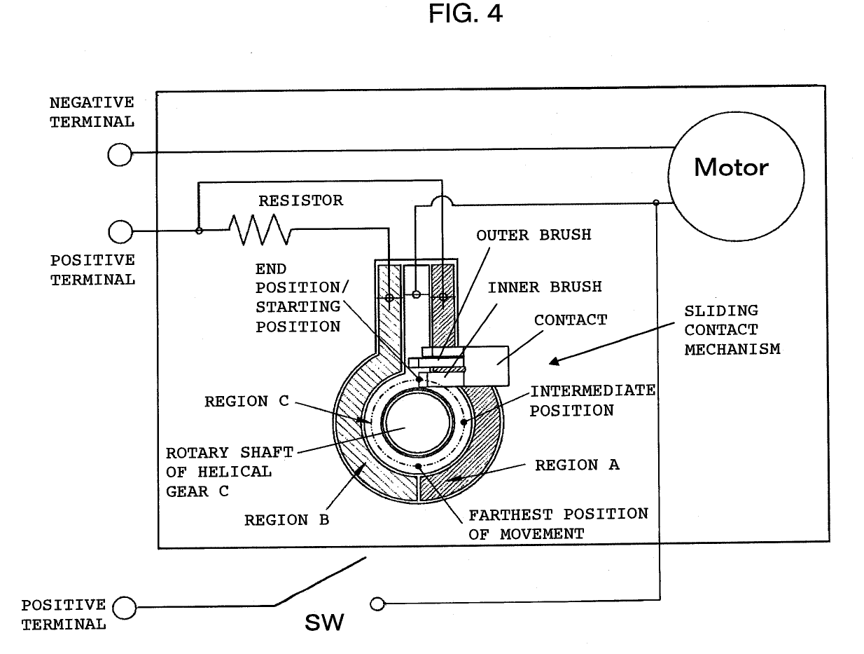

According to the configuration shown in FIG. 3A, the position of the second slit (the centerline of the movable plate) is set close, with respect to a direction orthogonal to the motor shaft, to the pin which is positioned at the intermediate position during pulling drive. When the pin pulls the movable plate at a position distant from the centerline of the movable plate (from the axis of reciprocative motion) with respect to the direction orthogonal to the motor shaft, a drive force is divided to the direction of reciprocative motion and the direction of rotation; thus, efficiency in utilization of the drive force drops. However, according to the illustrated configuration, the centerline of the movable plate is set close, with respect to the direction orthogonal to the motor shaft, to the pin positioned at the intermediate position, at which pulling force assumes a minimum value. By virtue of this, a drop in pulling drive force at the intermediate position can be reduced. By contrast, when the pin is positioned at the other intermediate position past the farthest position of movement and exerts pushing force on the movable plate, the pin is distant from the centerline of the movable plate; thus, because of increase in loss, the pushing drive force decreases further. However, usually, the rectilinear-motion actuator of this type actuates a load, such as a seat-unlocking device, when the pin is positioned at or immediately before the farthest position of movement; subsequently, the actuator is under no load in the course of the pin returning to the end position. Therefore, a drop in pushing drive force raises no problem, but rather, the pushing drive force must be far more lowered. A configuration for far more lowering the pushing drive force is described below with reference to FIG. 4.

FIG. 4 shows an example circuit configuration for driving the rectilinear-motion actuator of the first embodiment shown in FIG. 1. Current flows from a positive terminal of a DC power supply to a negative terminal of the DC power supply through a switch SW or a sliding contact mechanism and then through the motor. The sliding contact mechanism is adapted to detect a rotational position of the helical gear C as a position of movement of a movable section of the rectilinear-motion actuator. Upon detection of the farthest position of movement, the sliding contact mechanism inserts a series resistor into a motor power supply circuit, whereby the drive torque (rotational speed) of the motor can be lowered.

As shown in FIG. 2, the sliding contact mechanism includes a conductive member disposed in a predetermined pattern on an electrically insulative frame; a contact (brushes) in sliding contact with the conductive member; and a resistor. The conductive member is fixed under and concentrically with the helical gear C. The contact is fixed on a back side of the helical gear C, which rotates, at a position offset from the center of rotation of the helical gear C. During a single rotation of the helical gear C, the contact undergoes a single rotation while in sliding contact with an upper side of the conductive member.

FIG. 4 shows a conductive pattern provided by the conductive member. The illustrated conductive member is divided into an inner region (region C) and an outer region, which are electrically separated (insulated) from each other, and the outer region is further divided into region A and region B, which are electrically separated (insulated) from each other, at its center position (farthest position of movement). The regions A, B, and C have respective lead-out portions which extend from respective brush slide portions at the starting position/end position. Ends of wires are connected to ends of the respective lead-out portions. The contact is an assembly of an inner brush, which comes into sliding contact with the region C, and outer brushes, which come into sliding contact with the region A or the region B.

The switch SW is disposed externally of the actuator unit and is turned ON/OFF by human operation (manually). The position of the contract shown in FIG. 4 is the starting position/end position. At this time, the inner brush and the outer brushes of the contact are positioned on the region C; thus, the region C and the outer region A are disconnected from each other. When the switch SW is turned ON, current flows from the positive terminal to the negative terminal through the motor; thus, the motor rotates. When the motor rotates, the contact moves with rotation of the helical gear C and short-circuits the region C and the region A, thereby forming a motor power supply circuit including the contact. Thus, even when the switch is released and turned OFF, the motor is powered through the sliding contact mechanism and thus continues rotating. When the contact reaches the farthest position of movement, the outer brushes move to the region B from the region A, whereby the series resistor is inserted into the motor power supply circuit. As shown in FIG. 4, the two outer brushes are of different lengths. Thus, even when the outer brushes pass an insulating separation zone located at the farthest position of movement, either one of the two outer brushes is positioned on the conductive member, so that power supply to the motor is not interrupted. When the contact returns to the starting position/end position shown in FIG. 4, the region B and the region C are electrically disconnected from each other, so that the motor stops.

As described above, according to the configuration shown in FIG. 4, after the rectilinear-motion actuator drives a load at the time of the pin being positioned at or immediately before the farthest position of movement, the series resistor is inserted into the motor power supply circuit, whereby the rotational speed or drive torque of the motor can be lowered.

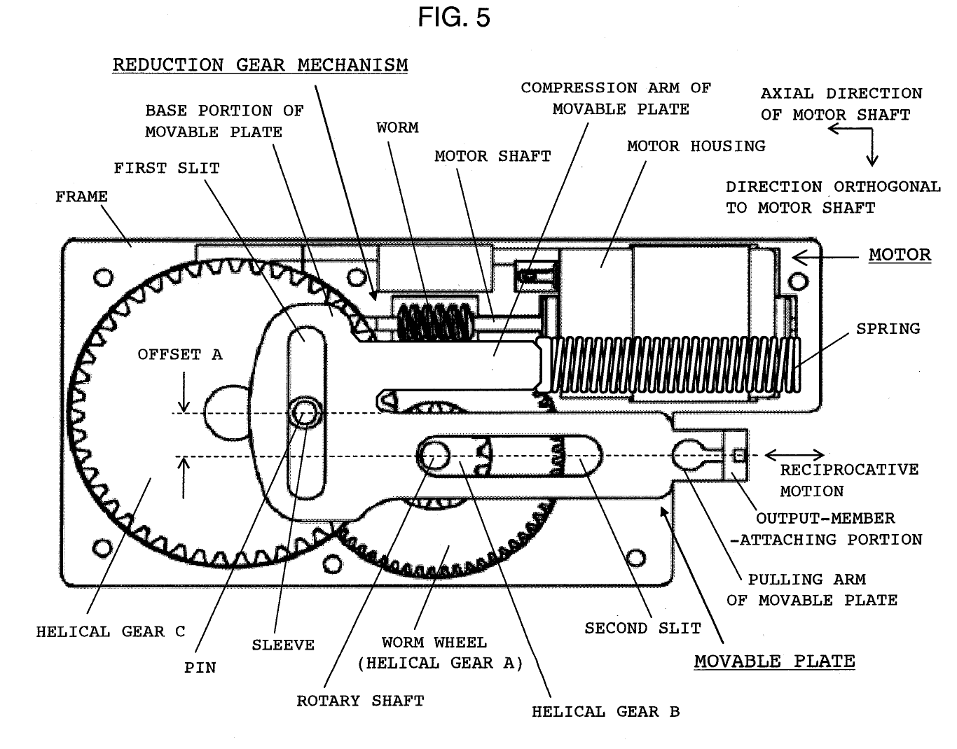

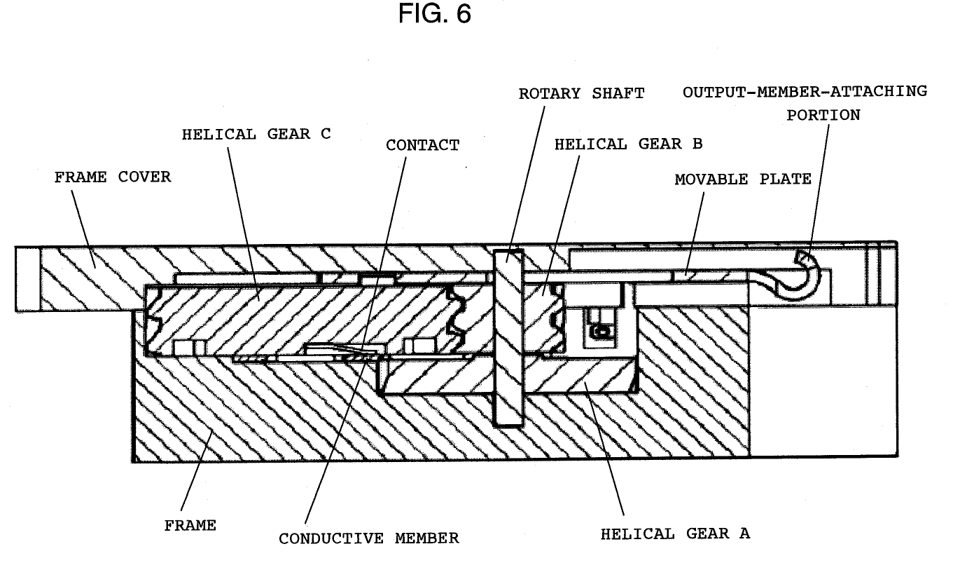

FIG. 5 is a top view showing the overall configuration of a rectilinear-motion actuator according to a second embodiment of the present invention. FIG. 5 shows a state in which a frame cover is removed. FIG. 6 is a sectional view, taken along the centerline of a movable plate, of the rectilinear-motion actuator of the second embodiment shown in FIG. 5. The rectilinear-motion actuator includes a motor, a reduction gear mechanism, and a rectilinear, reciprocative motion mechanism, which includes the movable plate and an elastic member (spring). The motor and the reduction gear mechanism coupled with the motor are similar in configuration to those of the rectilinear-motion actuator of the first embodiment, which has been described above with reference to FIG. 1, and repeated description thereof is omitted.

The rotation of a helical gear C, which partially constitutes the reduction gear mechanism, is converted to a rectilinear, reciprocative motion of the movable plate, which partially constitutes the rectilinear, reciprocative mechanism, via a pin which is fixed on the helical gear C at a position offset from the center of the helical gear C. The direction of the rectilinear, reciprocative motion is in parallel with the axis of a motor shaft. The movable plate assumes a shape resembling the letter U such that a pulling arm and a compression arm extend from a base portion in the same direction and in parallel with each other. The movable plate has a first slit (elongated hole) and a second slit (elongated hole), which are formed in the base portion and the pulling arm, respectively.

The first slit is arranged such that its longitudinal direction is orthogonal to the axis of the motor shaft and such that its longitudinal center is located on a line in parallel with the axis of the motor shaft and passing through the center of a last-stage gear. The pulling arm and the compression arm are located on opposite sides of the line passing through the center of the last-stage gear such that the pulling arm is located on the far side from the axis of the motor shaft, whereas the compression arm is located on the near side to the axis of the motor shaft. The pin provided on the helical gear C can move within the first slit. A sleeve is externally fitted to the pin in a slidably rotatable manner. When the pin moves within the first slit, the sleeve rotates, thereby lowering frictional force. The axis of reciprocative motion of the movable plate located at the widthwise center of the pulling arm is offset from the line passing through the center of the last-stage gear in the direction away from the motor shaft (indicated as “offset A” in FIG. 5). The offset of the centerline (axis of reciprocative movement) of the movable plate enables reduction in width of the actuator unit and enables utilization of force at a weakest-pulling-force position for conversion to a rectilinear, reciprocative motion with involvement of little loss.

The second slit is arranged such that its width is halved by the axis of reciprocative motion of the pulling arm of the movable plate and such that its longitudinal direction is in parallel with the axis of the motor shaft. The second slit is provided for receiving the common rotary shaft of a helical gear A and a helical gear B so as to avoid interference of the rotary shaft with the movable plate. The movable plate is guided as follows: a groove is provided in a frame or a frame cover, and the movable plate is fitted into the groove in such a manner as to be reciprocatively movable while being guided in a restrictive manner from opposite sides. The second slit functions as a guide for positioning the movable plate in a direction orthogonal to the motor shaft and as an additional guide for movement of the movable plate.

As a result, the second slit is also offset from the longitudinal center of the first slit (thus, from the center of the helical gear C) in the direction away from the motor shaft (thus, downward in FIG. 5). An offset A between the slits is equal to the offset between the center of rotation of the helical gears A and B and the center of rotation of the helical gear C.

An elastic member is provided at a distal end of the compression arm of the movable plate such that one end of the elastic member is supported by the distal end of the compression arm. The other end of the elastic member is supported by a stationary section, such as the frame or the frame cover. In addition to a coil spring shown in FIG. 5, a hydraulic damper, an air cylinder, or the like can be used as the elastic member. As will be described later in detail, the provision of the elastic member can enhance pulling force and can decelerate a return movement for reduction of noise. By means of disposing the pulling arm and the compression arm on opposite sides, respectively, with respect to the center of the movable plate, a compact design can be implemented.

By virtue of the above-mentioned configuration, by means of the pin moving within the first slit provided in the base portion of the movable plate, the rotation of the motor is converted to a rectilinear, reciprocative motion of the movable plate. A distal end of the pulling arm of the movable plate, which reciprocatively moves, has an output-member-attaching portion in alignment with the axis of reciprocative motion and to which an output member (wire or rod, not shown) is attached. The other end of the output member (not shown) is coupled with an external load, such as a simplified seat-unlocking device. The output member drives the external load in a pulling direction or a pushing direction.

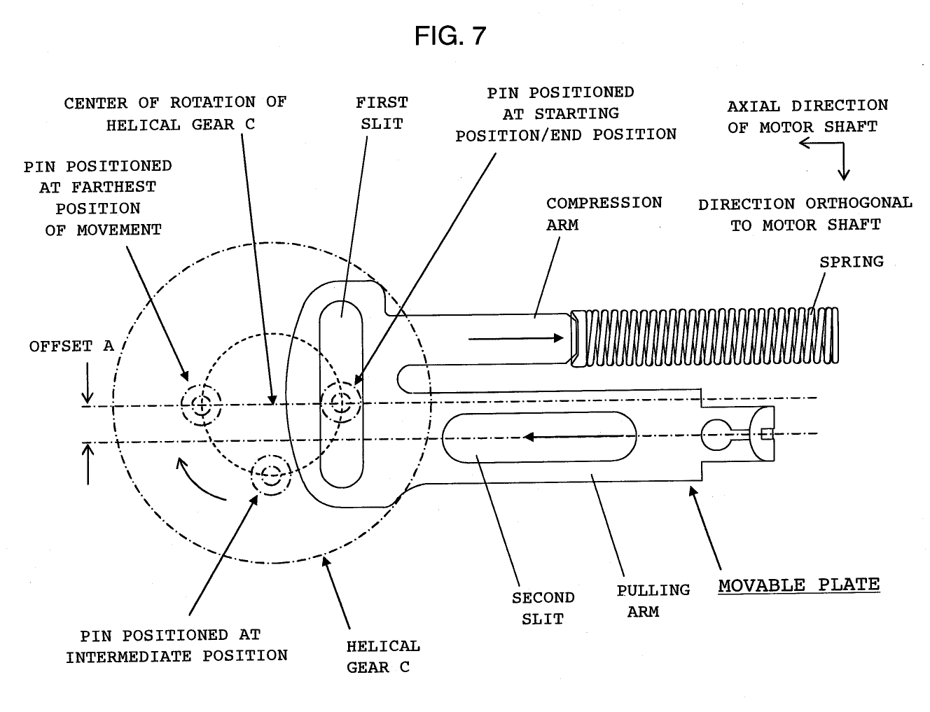

FIG. 7 is a view for explaining actions of the movable plate. An offset of the centerline of the pulling arm of the movable plate (offset of the second slit positionally coinciding with the centerline) from the center of rotation of the helical gear C (last-stage gear) is indicated as “offset A” in FIG. 7. The illustrated rectilinear-motion actuator has such a structure that the common rotary shaft of the helical gears A and B (thus, the second slit) is located on the offset axis, so that the rotary shaft can extend through the second slit. The offset of the centerline enables utilization of force at the weakest-pulling-force position for conversion to a rectilinear, reciprocative motion with involvement of little loss.

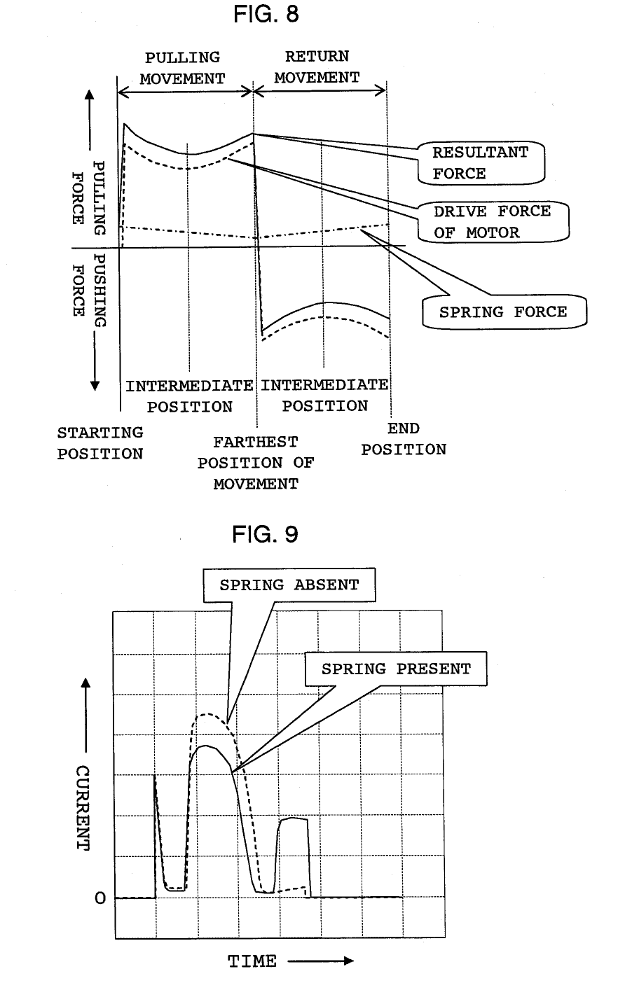

FIG. 7 shows three positions of the pin provided on the helical gear C during rotation of the helical gear C; namely, a starting position/end position, an intermediate position, and a farthest position of movement. As shown in FIG. 8, during a single clockwise rotation of the helical gear C from the starting position, the pin pulls the movable plate during travel from the starting position to the farthest position of movement and pushes the movable plate during travel from the farthest position of movement to the end position. FIG. 8 shows output characteristics of the rectilinear-motion actuator. In FIG. 8, the broken line represents a drive force of the motor; the dash-dot line represents a reaction force of the spring; and the solid line represents a resultant force of the drive force and the reaction force. In the course of pulling movement, the sum of a drive force of the motor and a spring force associated with extension of the spring in a compressed state is exerted on the movable plate as a resultant force. By contrast, in the course of pushing movement, the movable plate compresses the spring; thus, a force obtained by subtracting a spring force from the drive force of the motor is exerted on the movable plate as a resultant force. In both pulling movement and pushing movement, as shown in FIG. 8, the drive force assumes a minimum value at the respective intermediate positions.

As shown in FIG. 7, the position of the second slit (the centerline of the pulling arm) is set close, with respect to a direction orthogonal to the motor shaft, to the pin which is positioned at the intermediate position during pulling drive. When the pin pulls the movable plate at a position distant from the centerline of the pulling arm (from the axis of reciprocative motion) with respect to the direction orthogonal to the motor shaft, a drive force is divided to the direction of reciprocative motion and the direction orthogonal to the motor shaft; thus, efficiency in utilization of the drive force drops. However, according to the illustrated configuration, the centerline of the pulling arm is set close, with respect to the direction orthogonal to the motor shaft, to the pin positioned at the intermediate position, at which pulling force assumes a minimum value. By virtue of this, a drop in pulling drive force at the intermediate position can be reduced. By contrast, when the pin is positioned at the other intermediate position past the farthest position of movement and exerts pushing force on the movable plate, the pin is distant from the centerline of the pulling arm; thus, because of increase in loss, the pushing drive force decreases further. However, usually, the rectilinear-motion actuator of this type actuates a load, such as a seat-unlocking device, when the pin is positioned at or immediately before the farthest position of movement; subsequently, the actuator is under no load in the course of the pin returning to the end position. Therefore, a drop in pushing drive force raises no problem, but rather, the pushing drive force must be far more lowered. In order to far more lower the pushing drive force, the coil spring is provided.

The rectilinear-motion actuator of the present invention can be configured such that a rod is used as the output member so as to drive an external load by pushing. However, for example, in the case where the rectilinear-motion actuator is configured to drive a simplified seat-unlocking device, which serves as an external load, by pulling by use of a wire, a coil spring is assembled into the actuator in such a manner as to exert spring force on the movable plate in a direction along which the movable plate pulls the external load. This enables enhancement of pulling force by means of a resilient force of the coil spring without need to change motor specifications. Increase of pulling force can lower load current. As soon as the movable plate passes the farthest position of movement and enters a return movement, the movable plate begins to compress the coil spring. Thus, the return movement is decelerated, whereby noise is reduced.

FIG. 9 shows motor load current characteristics during a single reciprocation of the movable plate. As shown in FIG. 9, the actuator having the spring exhibits lower current and shorter working time of pulling movement as compared with the actuator not having the spring. After appearance of a starting current peak at the time of startup, a peak current during pulling drive of the movable plate can be lowered by virtue of assistance of the spring. Also, working time of return movement is elongated. However, after the movable plate passes the farthest position of movement, a motor load current flows for compressing the spring.

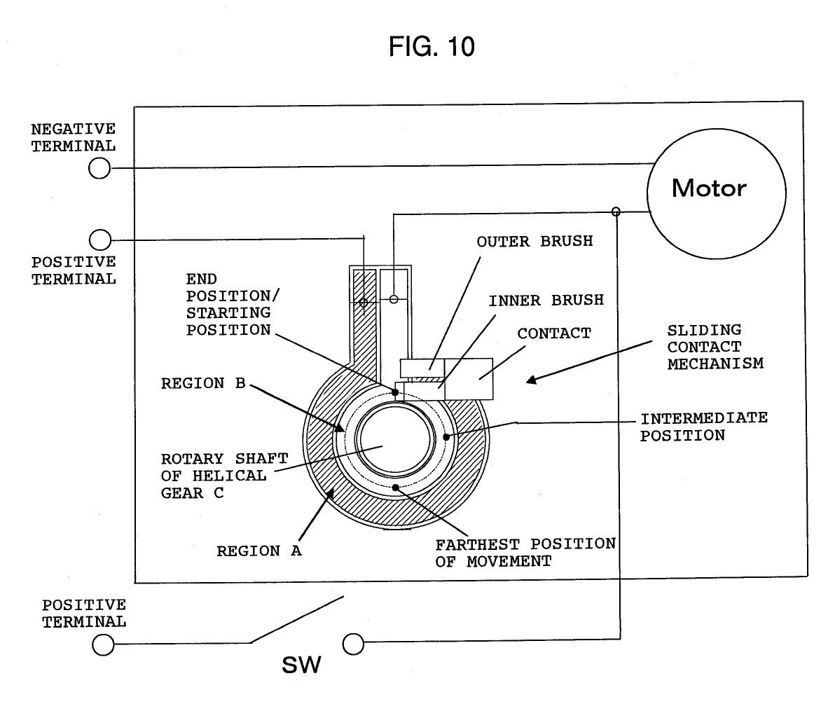

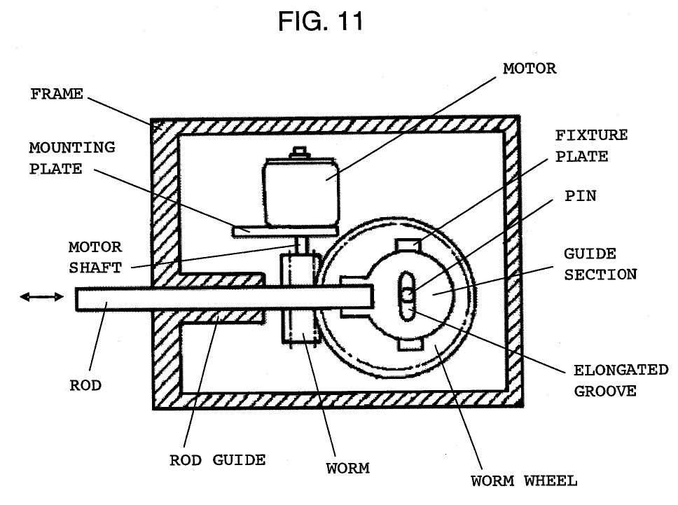

FIG. 10 shows an example circuit configuration for driving the rectilinear-motion actuator of the second embodiment shown in FIG. 5. Current flows from a positive terminal of a DC power supply to a negative terminal of the DC power supply through a switch SW or a sliding contact mechanism and then through the motor. As shown in FIG. 6, the sliding contact mechanism includes a conductive member disposed in a predetermined pattern on an electrically insulative frame, and a contact (brushes) in sliding contact with the conductive member. The conductive member is fixed under and concentrically with the helical gear C. The contact is fixed on a back side of the helical gear C, which rotates, at a position offset from the center of rotation of the helical gear C. During a single rotation of the helical gear C, the contact undergoes a single rotation while in sliding contact with an upper side of the conductive member.

The conductive member shown in FIG. 10 is divided into an inner region (region B) and an outer region (region A), which are electrically separated (insulated) from each other. The regions A and B have respective lead-out portions which extend from respective brush slide portions at the starting position/end position. Ends of wires are connected to ends of the respective lead-out portions. The contact is an assembly of an inner brush, which comes into sliding contact with the region B, and an outer brush, which comes into sliding contact with the region A.

The switch SW is disposed externally of the actuator unit and is turned ON/OFF by human operation (manually). The position of the contact shown in FIG. 10 is the starting position/end position. At this time, the inner brush and the outer brush of the contact are located on the region B; thus, the region B and the outer region A are disconnected from each other. When the switch SW is turned ON, current flows from the positive terminal to the negative terminal through the motor; thus, the motor rotates. When the motor rotates, the contact moves with rotation of the helical gear C and short-circuits the region B and the region A, thereby forming a motor power supply circuit including the contact. Thus, even when the switch is released and turned OFF, the motor is powered through the sliding contact mechanism and thus continues rotating. When the contact returns to the starting position/end position shown in FIG. 10, the region B and the region A are electrically disconnected from each other, so that the motor stops.

Thus, according to the rectilinear-motion actuator of the second embodiment shown in FIG. 5, the addition of the coil spring enables enhancement of pulling force and deceleration of a return movement for reduction of noise. Further, since compression of the coil spring is utilized for decelerating a return movement, use of a series resistor for decelerating the motor becomes unnecessary.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A rectilinear-motion actuator comprising:
a motor;
a reduction gear mechanism coupled with a motor shaft of the motor; and
a rectilinear, reciprocative motion mechanism for converting a rotary motion of a last-stage gear of the reduction gear mechanism to a rectilinear, reciprocative motion;
wherein the last-stage gear has a pin provided thereon which is offset from its center of rotation;
the rectilinear, reciprocative motion mechanism comprises a movable plate having a slit having a predetermined width and length, and allowing the pin to move within the slit; and
an axis of reciprocative motion of the movable plate is offset from a line passing through a center of the last-stage gear.

2. A rectilinear-motion actuator according to claim 1, wherein the reduction gear mechanism has a worm fixed to the motor shaft, and a worm wheel meshed with the worm, and
the movable plate has another slit whose width is halved by the axis of reciprocative motion of the movable plate and which receives a rotary shaft of the worm wheel so as to avoid interference of the rotary shaft with the movable plate.

3. A rectilinear-motion actuator according to claim 2, wherein a helical gear is coaxially provided on the rotary shaft of the worm wheel, and
the last-stage gear is meshed with the helical gear.

4. A rectilinear-motion actuator according to claim 3, wherein an output-member-attaching portion to which a load is attached is provided at an end portion of the movable plate in alignment with the axis of reciprocative motion of the movable plate.

5. A rectilinear-motion actuator according to claim 3, wherein the pin provided on the last-stage gear has a sleeve fitted externally thereto.

6. A rectilinear-motion actuator according to claim 3, further comprising a position detection mechanism for detecting a position of a movable section,
wherein a rotational speed or a rotational torque of the motor is varied according to a detected position of the movable section.

7. A rectilinear-motion actuator according to claim 6, wherein the position detection mechanism detects a rotational position of the last-stage gear.

8. A rectilinear-motion actuator according to claim 1, wherein an elastic member is disposed so as to act on the movable plate.

9. A rectilinear-motion actuator according to claim 8, wherein the elastic member is a coil spring which assists the movable plate with a pulling drive force in the course of pulling movement of the movable plate and which functions as a load in the course of pushing movement of the movable plate.

10. A rectilinear-motion actuator according to claim 9, wherein the reduction gear mechanism has a worm fixed to the motor shaft, and a worm wheel meshed with the worm, and
a first arm of the movable plate has another slit whose width is halved by the axis of reciprocative motion of the movable plate and which receives a rotary shaft of the worm wheel so as to avoid interference of the rotary shaft with the movable plate.

11. A rectilinear-motion actuator according to claim 10, wherein a helical gear is coaxially provided on the rotary shaft of the worm wheel, and
the last-stage gear is meshed with the helical gear.

12. A rectilinear-motion actuator according to claim 11, wherein an output-member-attaching portion to which a load is attached is provided at an end portion of the first arm in alignment with the axis of reciprocative motion of the movable plate.

13. A rectilinear-motion actuator according to claim 12, further comprising a sliding contact mechanism for causing the movable plate to perform a single reciprocation when a switch is turned on,
wherein the sliding contact mechanism comprises a conductive member provided in a predetermined pattern on an electrically insulative frame, and a contact in sliding contact with the conductive member,
the conductive member is fixed under and concentrically with the last-stage gear, whereas the contact is fixed on a back side of the last-stage gear, which rotates, at a position offset from a center of rotation of the last-stage gear, and
during a single rotation of the last-stage gear, the contact undergoes a single rotation while in sliding contact with an upper side of the conductive member.
